(19) United States
(12) Patent Application Publication
(10) Pub. No.: US 2015/0199358 A1
(43) Pub. Date: Jul. 16, 2015

(54) System and Method For Providing Unidimensional Scale Extraction from a Multidimensional Entity

(71) Applicant: Massachusetts Institute of Technology, Cambridge, MA (US)

(72) Inventor: Nwokedi Idika, Boston, MA (US)

(73) Assignee: Massachusetts Institute of Technology, Cambridge, MA (US)

(21) Appl. No.: 14/155,677

(22) Filed: Jan. 15, 2014

(51) Int. Cl. G06F 17/30; G06N 7/00

(52) U.S. Cl. CPC G06F 17/3053; G06F 17/30598; G06N 7/005

(57) ABSTRACT

A method is provided for deriving a unidimensional scale from an object having multiple attributes. An object and a set of attributes for the object are determined. Units of scale ranking the set of attributes are created, and the units are ordered. The set of attributes is grouped into pairs of attributes, where a preference for each pair of attributes is determined. The preferences are entered into a matrix, and a principle eigenvector of the matrix is extracted. A collection of possible attribute values is constructed.

### STATEMENT REGARDING FEDERALLY SPONSORED RESEARCH OR DEVELOPMENT

This invention was made with government support under Contract No. FA8721-05-C-0002 awarded by the U.S. Air Force. The government has certain rights in the invention.

### FIELD OF THE INVENTION

The present invention relates to data analysis, and more particularly, is related to the analytic hierarchy process.

### BACKGROUND OF THE INVENTION

The analytic hierarchy process (AHP) is a structured technique for organizing and analyzing complex decisions. AHP, based on mathematics and psychology, was developed by Thomas L. Saaty in the 1970s, and has been extensively studied and refined thereafter.

An AHP hierarchy is a structure for modeling a decision. The hierarchy consists of an overall goal, or functional objective, a group of options or alternatives for achieving the goal, and a group of factors or attributes that relate the alternatives to the goal. The attributes can be further broken down into one or more layers of sub-attributes. While an attribute may apply uniformly, it may instead have graded differences, wherein the amount or degree of the attribute may contribute to whether the attribute is desirable or undesirable. For example, one volume level may make a musical performance enjoyable, where excessive volume may make the musical performance intolerable. In that case the attribute is divided into sub-attributes indicating different intensities of the sub-attribute, for example, low, medium, and high, and these intensities are prioritized through comparisons under the parent attribute.

AHP is applicable for group decision making, and is used in a wide variety of decision situations, in fields such as government, business, industry, healthcare, and education. AHP helps decision makers find a structure that best suits their goal and their understanding of the problem. AHP provides a comprehensive and rational framework for structuring a decision problem, for representing and quantifying elements of the decision problem, for relating those elements to one or more overall goals, and for evaluating alternative solutions.

In general, under AHP a decision problem is decomposed into a hierarchy of more easily comprehended sub-problems, each of which can be analyzed independently. The elements of the hierarchy can relate to any aspect of the decision problem, for example, tangible or intangible aspects, carefully measured or roughly estimated aspects, well understood or poorly-understood aspects, or other aspects that apply to the decision at hand.

Once the hierarchy is built, various elements are systematically evaluated by comparing them to one another two at a time regarding their impact on an element above them in the hierarchy. In making the comparisons, the decision makers can use concrete data about the elements, but they typically use their judgments about the relative meaning and importance of the elements. Under AHP, human judgments, and not just the underlying information, can be used in performing the evaluations.

The evaluations are converted to numerical values that can be processed and compared over the entire range of the problem. The mathematical processing in AHP is based on linear algebra. A numerical weight or priority is derived for each element of the hierarchy, allowing diverse and often incommensurable elements to be compared to one another in a rational and consistent way.

Numerical priorities are calculated for each of the decision alternatives. These numbers represent the relative ability of alternatives to achieve the decision goal, allowing a straightforward consideration of the various courses of action.

Existing methods for creating a scale from multiple attributes include condition setting and simple aggregation. The result of condition setting is a rubric scale. The result of simple aggregation is a multidimensional scale. A rubric scale stipulates the condition required for an observation to have a specific value or value range. Such an approach can be difficult because there are many conditions and factors that must be accounted for. For instance, the number of levels must be determined, and the various attributes under consideration must be accounted for. Moreover, there is no standard way for checking for inconsistencies in rubric development.

Multidimensional scales maintain a scale for each set of the attributes of interest. However, with this approach there can be ambiguous value combinations with multiple dimensions. The inability to interpret such values limits the utility of maintaining multidimensional scales. Therefore, there is a need in the industry to address one or more of the above mentioned shortcomings.

### SUMMARY OF THE INVENTION

Embodiments of the present invention provide unidimensional scale extraction from a multidimensional entity. Briefly described, a first aspect the present invention is directed to a method for deriving a unidimensional scale from an object comprising multiple attributes, using a processor and memory, having the steps of determining the object to measure, determining a set of attributes of the object, creating units of a scale ranking the set of attributes, and ordering the units of the scale to determine the unidimensional scale.

Briefly described, in architecture, a second aspect the present invention is directed to a system including a processor and memory configured to derive a unidimensional scale from an object comprising multiple attributes, where the processor is configured to perform the steps of determining the object to measure, determining a set of attributes of the object, determining a quantitative importance of an attribute, creating units of a scale ranking the set of attributes, and ordering the units of the scale to determine the unidimensional scale.

Briefly described, in architecture, a third aspect the present invention is directed to a computer readable media containing non transient instruction that when executed by a processor derive a unidimensional scale from an object comprising multiple attributes, the instructions including the steps of determining the object to measure, determining a set of attributes of the object, determining a quantitative importance of an attribute, creating units of a scale ranking the set of attributes, and ordering the units of the scale to determine the unidimensional scale.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a block diagram of an exemplary prior art AHP hierarchy.

FIG. 2 is a schematic diagram illustrating an example of a system for executing functionality of the present invention.

FIG. 3 is a flowchart of an exemplary method for deriving a unidimensional scale from an entity comprising multiple attributes.

FIG. 4 is a flowchart expanding and providing more detail on determining the quantitative importance of each attribute.

FIG. 5 is a flowchart expanding and providing additional detail of creating units of a scale.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention extend a known AHP methodology to create a unidimensional scale by careful construction of the input of the AHP and additional permutations of the output of the AHP.

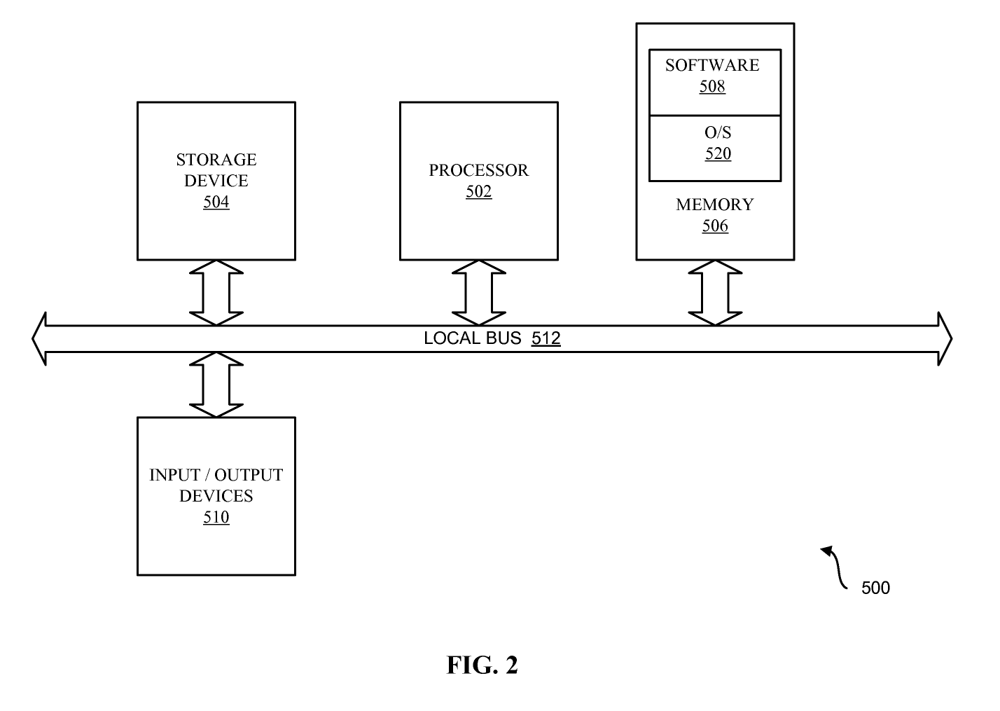

A system for executing the functionality described in detail below may be a computer, an example of which is shown in the schematic diagram of FIG. 2. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

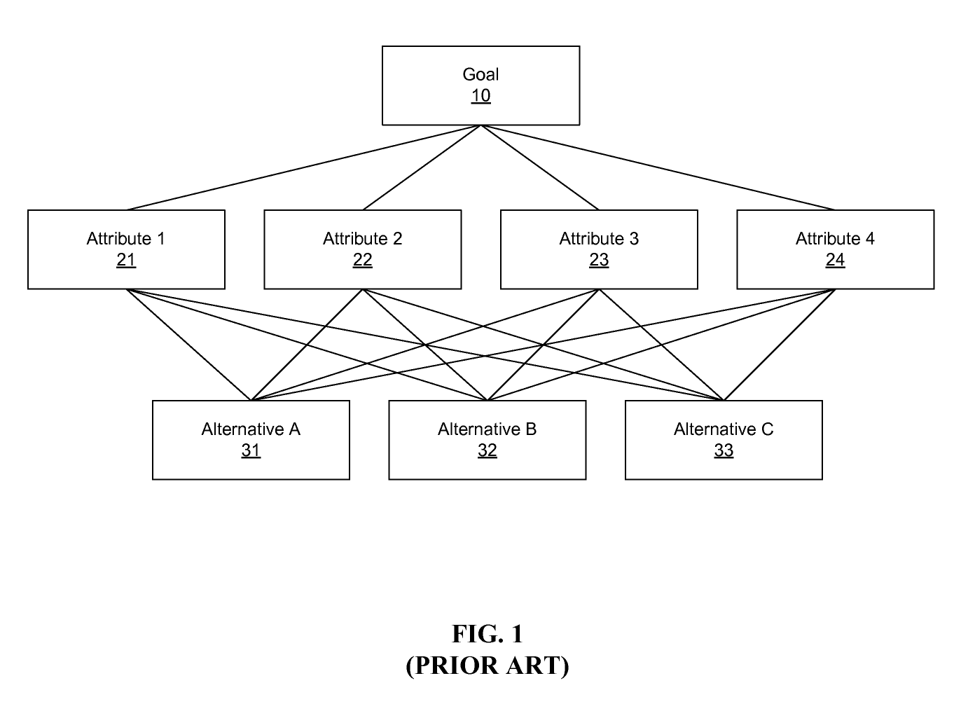

In general, a hierarchy is created around a decision problem having an identified goal. An example of a basic AHP hierarchy diagram is shown in FIG. 1, having a goal 10. In this example, three alternative ways of reaching the goal 10, alternative A 31, alternative B 32, and alternative C 33, and four attributes 21-24 the alternatives 31-33 are measured against. The example hierarchy of FIG. 1 is depicted, with the goal at the top, the three alternatives 31-33 at the bottom, and the four attributes 21-24 in between the top and the bottom. Each box in the diagram is called a node. A node that is connected to one or more nodes in a level below it is called a parent node. The nodes connected to the parent node from the bottom of the parent node are called children of the parent. The goal 10 is the parent of the four attributes 21-24, and the four attributes 21-24 are children of the goal 10. Each attribute 21-24 is a parent of the three alternatives 31-33. Note that while there are only three alternatives 31-33, each is repeated under each of its parent attributes 21-24. Examples of problems that may be modeled with AHP include selecting an officer from a group of candidates, or selecting a new car to purchase from a set of selected cars.

Once the hierarchy has been constructed, it is analyzed using a series of pairwise comparisons that derive numerical scales of measurement for the nodes. The attributes 21-24 are pairwise compared against the goal 10 for importance. The alternatives 31-33 are pairwise compared against each of the attributes 21-24 for preference. The comparisons are processed mathematically, and priorities are derived for each node.

Consider the example above of selecting an officer. An important task of the decision makers is to determine the weight to be given each attribute in making the choice of an officer. Another important task is to determine the weight to be given to each candidate with regard to each of the attributes. The AHP provides a meaningful and objective numerical value for each of the four attributes.

Priorities are numbers associated with the nodes of an AHP hierarchy. They represent the relative weights of the nodes at any level of the hierarchy. Priorities are typically chosen as absolute numbers between zero and one, without units or dimensions. A node with priority 0.200 has twice the weight as a node with priority 0.100. Depending on the problem being modeled, weight can refer to importance, preference, likelihood, or whatever factor is being considered for that level of the hierarchy.

As mentioned above, condition setting has previously resulted in a rubric scale, and the result of simple aggregation is a multidimensional scale, which may be problematic to interpret, whereas a unidimensional scale may provide results that are more easily understood.

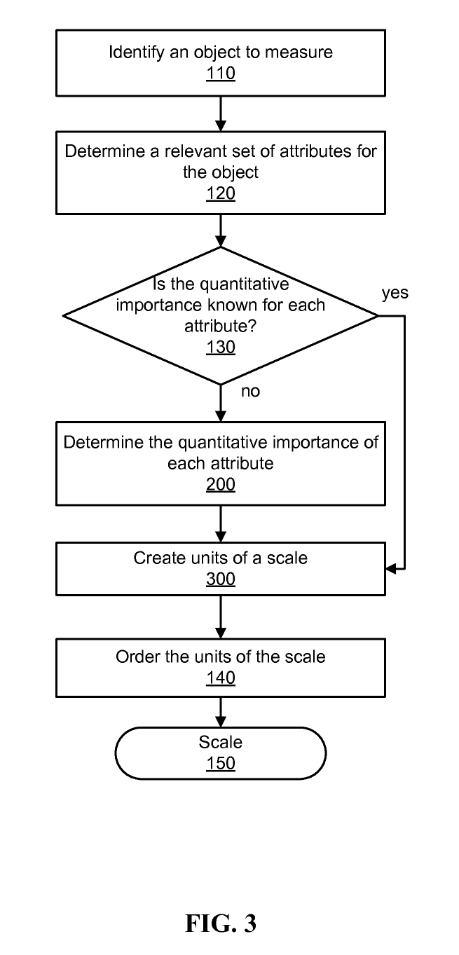

A first exemplary process for providing a unidimensional scale from an AHP hierarchy is shown by FIG. 3. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A goal, or object, is identified to be measured, as shown by block 110. A relevant set of attributes for the object is determined, as shown by block 120. If the quantitative importance is known for each attribute, as shown by block 130, the units of scale are created, as shown by block 300, and described further below. If the quantitative importance is not known for each attribute, the quantitative importance of each attribute is determined, as shown by block 200, and described further below. The units of the scale are ordered, as shown by block 140, resulting in the ordered scale 150. The steps of this process may be executed, for example, by a computer.

It should be noted the goal and object are not necessarily the same. For example, one may wish to trust the security of a machine. In this case, the object is the machine, but the goal is measuring the security of the machine. The “security of the machine” is a concept, but not a physical thing.

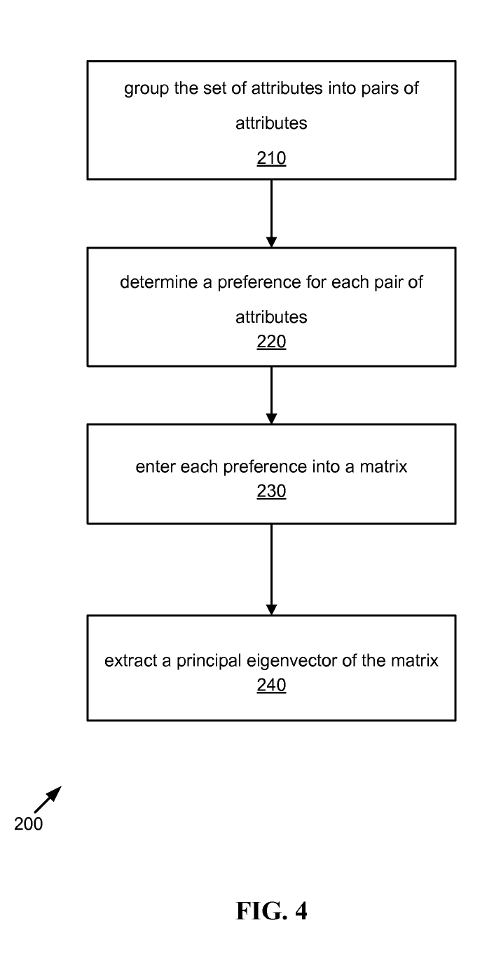

Under the first exemplary process, determining the quantitative importance of each attribute 200 (FIG. 3) may include the steps shown in the flowchart of FIG. 4. The set of attributes may be grouped into pairs of attributes, as shown by block 210. For example, let a matrix A be the set of attributes for the object. A preference for each pair of attributes may be determined for each pair of attributes (aᵢ, aⱼ) in A, as shown by block 220. The preference a user has between a pair of items may be dependent on the context. For example, if an organization was determining what security solution to purchase and the three attributes of interest were confidentiality, integrity and availability, context of what the solution would be used for would be important. If, for example, this security solution is being considered for protecting highly sensitive information, confidentiality may be the most preferred attribute followed by integrity and then availability. The magnitude of this preference would be represented for any pair of these attributes with numbers.

Each preference may be entered into a matrix, as shown by block 230. A principal eigenvector of the matrix may be extracted, as shown by block 240. If the principal eigenvector is sufficiently consistent, it is accepted, as is described further below. In order to determine whether a vector is sufficiently consistent, a threshold value tₕ is chosen, and the difference of the maximum eigenvalue and the number of attributes being considered is computed. The result is normalized by the number attributes. For example, a threshold value may be 0.1 (see eq. 3 below). The accepted principal eigenvector corresponds to the quantitative importance for each attribute aᵢ.

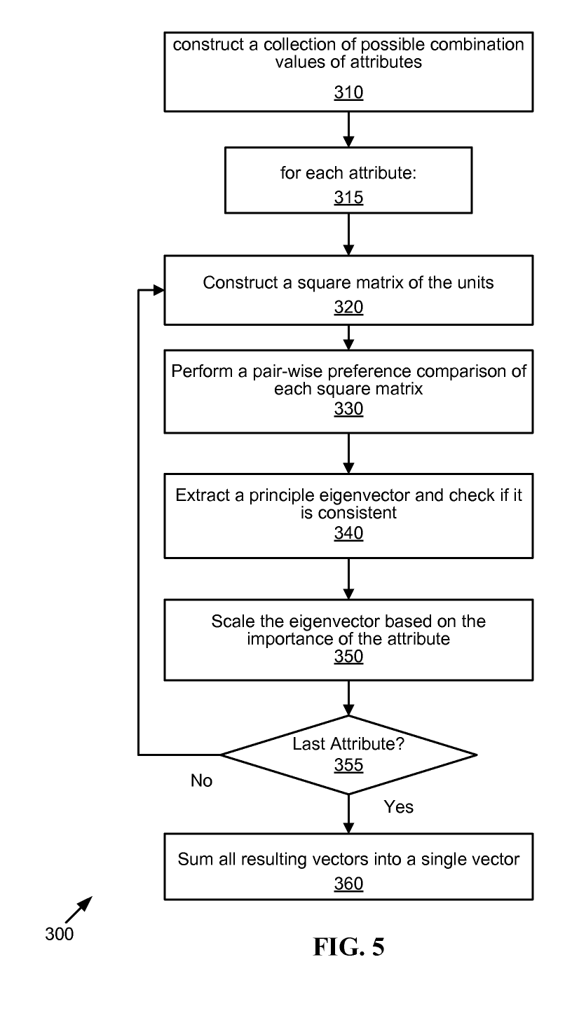

Under the first exemplary process, creating units of a scale 300 (FIG. 3) may include the steps shown in the flowchart of FIG. 5. A collection of all possible combination values of attributes is constructed, as shown by block 310. For example, if there are ten attributes, and each attribute can take on two possible values, there will be 10² possible units.

For each attribute (as shown by block 315), a square matrix of the units is constructed, as shown by block 320. A pair-wise preference comparison of each square matrix is performed, as shown by block 330. A principle eigenvector is extracted, as shown by block 340. The principle eigenvector is checked for consistency. If the eigenvector is not consistent, the attributes may be adjusted to ensure consistency, as described above. Once the eigenvector is determined to be consistent, the eigenvector is scaled based on the importance of the attribute as shown by block 350. This importance is derived from the principal eigenvector produced earlier for the attributes, as shown by block 240 (FIG. 4). If the attribute is not the last attribute (block 355), a matrix is constructed for the next attribute, back at block 320. Once eigenvectors for each attribute have been determined, the resulting eigenvectors are summed into a single vector, as shown by block 360.

An example of this process follows. The first step is to create a goal. Creating a goal involves deriving a unidimensional scale for Xᵢ, where X is an entity with multiple measurable attributes of interest. A value of an attribute must exist on an ordinal, interval, or ratio scale.

Let A be a set of all measurable attributes of interest for an entity, and let k=|A|. For all measurable attributes aⱼ,

aᵢεA (Eq. 1)

provides a ranking for each attribute such that

rank(aⱼ)≦rank(aᵢ) (Eq. 2)

An attribute with a higher rank is considered more important than an attribute with a lower rank. A k-by-k matrix C may be constructed such that the rows correspond to attributes a₁ to aₖ, and the columns correspond to a₁ to aₖ. A weighting function f(aᵢ, aⱼ, rank, C) determines which of two attributes aᵢ or aⱼ is more important. The weighting function f is subjective, and may be defined to favor desirable attributes over undesirable attributes based on the preferences of the user. Based on this determination, the function f maps the value of the range of [1/9-9] to cᵢⱼ and its reciprocal value in cᵢⱼ. The function f assigns a larger value (weight) to cᵢⱼ the more important aᵢ is compared to aⱼ. The function f returns a unity value if the importance of aᵢ is equal to the importance of aⱼ. Once the function f has assigned values to all cells of the matrix C, a principle eigenvector, ĉ, of the matrix C is computed. The vector ĉ corresponds to the relative importance of the attributes. This vector is preferably normalized so the sum of its components is 1.

If the weighting represented in the vector ĉ does not reflect the importance of the attributes, then C may be checked for consistency. A matrix is consistent if its principal eigenvalue, λ_{principal}, equals k. The equation

[λ_{principal}−k]/k−1 (Eq. 3)

computes a Consistency Index (CI) for C. The closer CI is to zero, the more consistent the assignments in C have been. Another statistic called the Consistency Ratio (CR) may be computed to determine whether to keep the vector ĉ. One may choose to not keep the eigenvector, for example, because it is too inconsistent. In this case, the most inconsistent entries in the matrix are identified and their values are adjusted. Afterward, the eigenvector is recomputed and again checked for consistency. Inconsistent cells in the matrix C may be identified by techniques known to persons having ordinary skill in the art. For example, assuming eᵢⱼ=cᵢⱼ*vⱼ/vᵢ, where the values vᵢ and vⱼ are derived from the principal eigenvector extracted from the matrix C, the entry with the largest value has the most inconsistency, and should be fixed first.

Possible attribute values that may ultimately appear on the unidimensional scale are computed as follows. First, the values an attribute may have (values of interest) are enumerated and ranked. The set of values for aᵢ is indicated by

Vᵢ=values[aᵢ] (Eq. 4).

Second, the items in Vᵢ are ranked such that

rank(v_{g})≦rank(vₕ) (Eq. 5)

holds true for attribute values vₕ and v_{g}. Third, a set cross product of all specified attribute values is performed. Scale values result from the set

S=V₁×V₂× . . . ×Vₖ (Eq. 6)

For example, let m=|S|. Next, let W be an m-by-m matrix where the rows correspond to s₁ to sₘ and the columns correspond to s₁ to sₘ. And let there be K copies of this matrix so that each attribute aᵢ is associated with matrix Wᵢ. The function ƒ assigns values into Wᵢ with respect to aᵢ only. So the function

ƒ(sⱼ,sₖ,aᵢ,rank,Wᵢ) (Eq. 7)

assigns values in the range of [1/9-9] to wⱼₖ and the reciprocal value to wₖⱼ. When ƒ attempts to determine which is more important between sⱼ and sₖ, the function uses the components of sᵢ and sₖ belonging to the values (aᵢ) to make the determination. As discussed previously, ƒ returns 1 if the components sᵢ and sₖ are equal. It should be noted the range of [1/9-9] represents “The Fundamental Scale” of pairwise comparison given by the AHP method. However, it's possible to create entries in the range of (0-infinity).

ŵₗ corresponds to the principal eigenvector for the matrix Wᵢ. The consistency, as described above, is checked for each matrix with k replaced by m. Each ŵₗ is normalized so that its components sum to 1. ŵₗ is weighted by ĉ(i), which corresponds to the importance of aᵢ. The resulting eigenvectors are summed together, which can be represented as

ŷ=Σŵₗ×ĉ(i) (Eq. 8).

Sorting the eigenvector ŷ produces a unidimensional scale.

There are many commercial applications for the AHP-based approach of the present invention. Areas for commercial application include, but are not limited to, security assessment, dating profiling, human resource assessment, virtual/physical property evaluation, and product quality control, among others.

For example, a security company producing multiple measurements of a network of an enterprise may wish to provide a single number that represents the security posture of the organization. For instance, the security company may measure the Mean-Time-To Failure (MTTF), Network Compromise Percentage (NCP), and the number of compromised hosts in the past thirty days. Producing a single number for these very different metrics may prove useful to clients of the security company that wish to provide a dashboard to help indicate the quality of the overall security for the monitored organizations.

As another example, a dating website may have clients enter the preferences of what they want in some fashion, for example, marriage status, number of children, hair color, and height range. If embodiments of this invention are used, potential daters may be scaled according to preferences and displayed against the scale to help determine a person the client may wish to date. For instance, a user may only be willing to date a person in the top quartile of his or her scale.

Human Resource (HR) departments could use embodiments of the disclosed tool to help determine which employees to hire. Using the scale, HR could hire people within a particular range on the scale. Managers could use this scale to help determine various employment actions, for example, whether to hire, promote, or fire an individual.

Developing a methodology for determining how valuable a website or real estate property is could be valuable to those considering purchasing or selling such a website or property. There are many factors that may go into this decision, and a unidimensional scale may help make the overall assessment easier to interpret. The same holds true for assessing efficiency of an organization or the quality of a product to be released to the public.

The advantages of the AHP-based approach of the present invention is that it requires negligible user effort. The user has the ability to personalize his scale, and the result of the analysis is a unidimensional scale with consistency checks.

This approach provides a systematic way of deriving a scale, thus the user need not expend the effort to derive his own scale. The user identifies the values of the attributes he deems most important, and ranks the attributes. A user can be reasonably expected to know for any one attribute how one attribute value ranks with respect to another attribute value. Unlike the prior art, the user no longer has to consider the case where he has to consider a multidimensional scale containing multiple attributes all at once.

User preferences are captured in the choice of attributes, the ranking of attributes, the choice of attribute values, and the ranking of attribute values. User preference is captured in the choice of attributes and the choice of attribute values because, implicitly, attributes that are not chosen have an importance value of 0. By ranking these attributes and their associated values and having a mapping function that considers these rankings when assigning values from The Fundamental Scale of Pairwise Comparison (or their reciprocal), user preferences are captured in the weighting of the attributes. Also, if the obtained CR value is unacceptable for the user, he would know that his preferences are too inconsistent to produce a meaningful vector of importance values. In contrast, with the rubric scale, if any consistency checking is done at all, it may be arduous to detect.

The unidimensional scale is valuable because it allows a user of this scale to compare any two values. It removes the ambiguity possible in multidimensional scales. The unidimensional scale provides context for values of the scale. This way, a user can identify problems in the scale. For example, if one value appears around other values known to have significantly different real-world implications, there may be a need to correct the issue by making a matrix (or multiple matrices) more consistent.

In summary, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system comprising a memory and a processor configured to derive a unidimensional scale from an object comprising multiple attributes, where the processor is configured to perform non-transitory steps stored on the processor comprising:
determining the object to measure;
determining a set of attributes of the object;
determining a quantitative importance of an attribute;
creating units of a scale ranking the set of attributes; and
ordering the units of the scale to determine the unidimensional scale.

2. The system of claim 1, wherein the processor is further configured to perform the steps of:
grouping the set of attributes into pairs of attributes;
determining a preference for each pair of attributes;
entering each preference into a matrix; and
extracting a principal eigenvector of the matrix.

3. The system of claim 2, wherein creating units of a scale further comprises the steps of:
constructing a collection of possible combination values of attributes;
for each attribute,
constructing a square matrix of the units;
performing a pairwise preference comparison of each square matrix;
extracting a principle eigenvector; and
scaling the eigenvector based on the importance of the attribute; and
summing each resulting eigenvector into a single vector.

4. A method for deriving a unidimensional scale from an object comprising multiple attributes with a memory and a processor configured to execute non-transitory steps stored on the memory, comprising the steps of:
determining the object to measure;
determining a set of attributes of the object;
creating units of a scale ranking the set of attributes; and
ordering the units of the scale to determine the unidimensional scale.

5. The method of claim 4, further comprising the step of determining a quantitative importance of an attribute.

6. The method of claim 5, further comprising the steps of:
grouping the set of attributes into pairs of attributes;
determining a preference for each pair of attributes;
entering each preference into a matrix; and
extracting a principal eigenvector of the matrix.

7. The method of claim 6, wherein creating units of a scale further comprises the steps of:
constructing a collection of possible combination values of attributes;
for each attribute,
constructing a square matrix of the units;
performing a pairwise preference comparison of each square matrix;
extracting a principle eigenvector; and
scaling the eigenvector based on the importance of the attribute; and
summing each resulting eigenvector into a single vector.

8. The method of claim 7, further comprising the step of checking the consistency of the eigenvector.

9. The method of claim 7, further comprising the step of summing two or more eigenvectors into a single vector.

10. The method of claim 4, further comprising the step of sorting a resultant vector.

11. A computer readable media containing non transient instruction that when executed by a processor derive a unidimensional scale from an object comprising multiple attributes, the instructions comprising the steps of:
determining the object to measure;
determining a set of attributes of the object;
determining a quantitative importance of an attribute;
creating units of a scale ranking the set of attributes; and
ordering the units of the scale to determine the unidimensional scale.

12. The computer readable media of claim 11, wherein the instructions further comprise the steps of:
grouping the set of attributes into pairs of attributes;
determining a preference for each pair of attributes;
entering each preference into a matrix; and
extracting a principal eigenvector of the matrix.

13. The computer readable media of claim 12, wherein creating units of a scale further comprises the steps of:
constructing a collection of possible combination values of attributes;
for each attribute,
constructing a square matrix of the units;
performing a pairwise preference comparison of each square matrix;
extracting a principle eigenvector; and
scaling the eigenvector based on the importance of the attribute; and
summing each resulting eigenvector into a single vector.
